(19) United States
(12) Patent Application Publication
(10) Pub. No.: US 2009/0085394 A1
(43) Pub. Date: Apr. 2, 2009

(54) BELLY DUMP TRAILER

(75) Inventor: Brian C. LEMMONS, Katy, TX (US)

Correspondence Address: SMITH IP SERVICES, P.C., P.O. Box 997, Rockwall, TX, 75087, US

(73) Assignee: VANTAGE TRAILER, INC., Katy, TX (US)

(21) Appl. No.: 12/238,680

(22) Filed: Sep. 26, 2008

Related U.S. Application Data
(60) Provisional application No. 60/975,801, filed on Sep. 27, 2007.

(51) Int. Cl. B60P 1/56

(52) U.S. Cl. 298/27

(57) ABSTRACT

A belly dump trailer including a hopper having sides made up of multiple hollow extruded aluminum panels. Cones are attached at forward and rearward ends of the hopper. The cones are made of aluminum. The cones are hollow and each cone includes internal stiffener rings supporting an outer shell. The hopper sides include top, side and bottom rails interconnected to the panels. Each of the top, side and bottom rails is made of a hollow extruded aluminum. Another belly dump trailer includes a hopper and a cone attached to the hopper, the cone having an axis which is inclined downwardly in a direction away from the hopper. Another belly dump trailer includes a hopper having first and second side walls each made up of multiple hollow panels, and front and rear walls; a first cone attached to the front wall; and a second cone attached to the rear wall.

### CROSS-REFERENCE TO RELATED APPLICATION

The present application claims the benefit under 35 USC §119(e) of the filing date of U.S. provisional application no. 60/975801, filed Sep. 27, 2007 and entitled Belly Dump Trailer. The entire disclosure of the provisional application is incorporated herein by this reference.

### BACKGROUND

The present invention relates generally to trailer construction and, in an embodiment described herein, more particularly provides a belly dump trailer.

It is desirable to provide belly dump trailers which are light in weight, durable, capable of hauling heavy loads, economical to produce and efficient in use. It is accordingly one of the purposes of the present invention to provide a belly dump trailer which satisfies one or more of these objectives.

### SUMMARY

In the present specification, a belly dump trailer is provided which solves at least one problem in the art. One example is described below in which a hopper of the belly dump trailer is constructed of hollow extruded aluminum panels. Another example is described below in which the belly dump trailer has frusto-conical shaped forward and rearward ends.

In one aspect, a belly dump trailer is provided which includes a hopper having sides made up of multiple hollow extruded aluminum panels. The trailer may further include cones attached at forward and rearward ends of the hopper. The cones may be made of aluminum. The cones may be hollow and each cone may include internal stiffener rings supporting an outer shell.

Each of the hopper sides may include top, side and bottom rails interconnected to the panels. Each of the top, side and bottom rails may be made of a hollow extruded aluminum.

In another aspect, a belly dump trailer is provided which includes a hopper and a cone attached to the hopper. The cone has an axis which is inclined downwardly in a direction away from the hopper.

In yet another aspect, a belly dump trailer is provided which includes a hopper having first and second side walls each made up of multiple hollow panels, a front wall and a rear wall; a first cone attached to the front wall; and a second cone attached to the rear wall.

These and other features, advantages, benefits and objects will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is a side elevational view of a belly dump trailer embodying principles of the present invention;

FIG. 2 is a top plan view of the trailer;

FIG. 3 is an isometric and longitudinal vertical plane cross-sectional view of the trailer;

FIG. 4 is a longitudinal horizontal plane cross-sectional view of the trailer;

FIG. 5 is an isometric and longitudinal horizontal plane cross-sectional view of the trailer;

FIG. 6 is an enlarged scale lateral cross-sectional view of the trailer;

FIG. 7 is a cross-sectional view of a top rail of a hopper of the trailer;

FIG. 8 is a cross-sectional view of a side stiffener rail of the hopper;

FIG. 9 is a cross-sectional view of a bottom rail of the hopper;

FIG. 10 is a cross-sectional view of interlocking panel edges of the hopper;

FIG. 11 is a longitudinal vertical plane cross-sectional view of the trailer; and

FIG. 12 is an enlarged scale cross-sectional view of a top rail of a rear wall of the hopper.

### DETAILED DESCRIPTION

It is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

In the following description of the representative embodiments of the invention, directional terms, such as “above”, “below”, “upper”, “lower”, etc., are used for convenience in referring to the accompanying drawings.

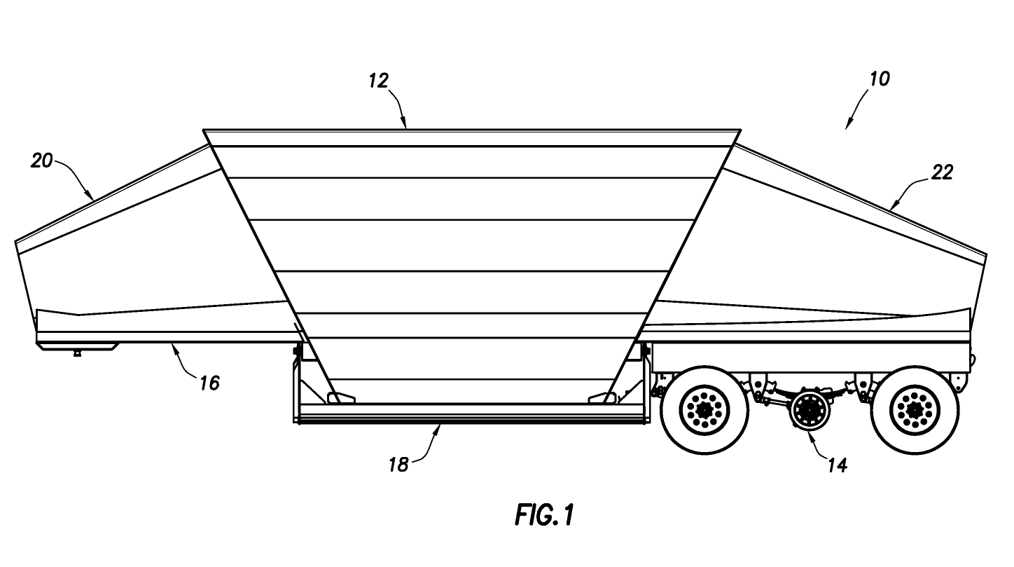

Representatively illustrated in FIGS. 1-12 is a belly dump trailer 10 which embodies principles of the present invention. The trailer 10 includes a hopper 12, a suspension system 14, a frame 16, belly dump doors 18, a frusto-conical leading cone 20 at a forward end of the hopper, and a frusto-conical following cone 22 at a rearward end of the hopper.

As used herein, the term “cone” is used to indicate a structure having a conical shape, including a frusto-conical shape.

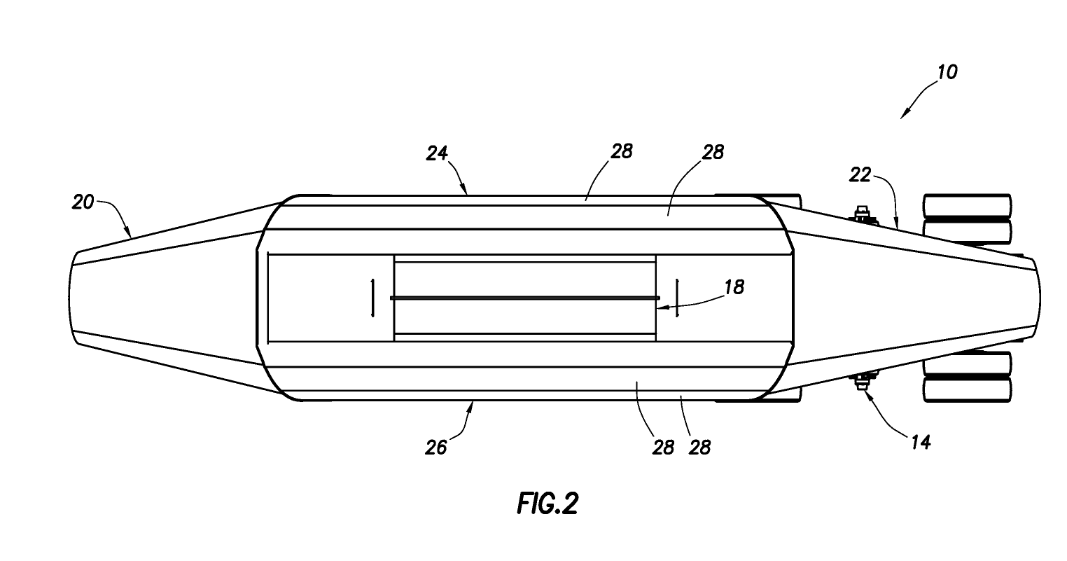

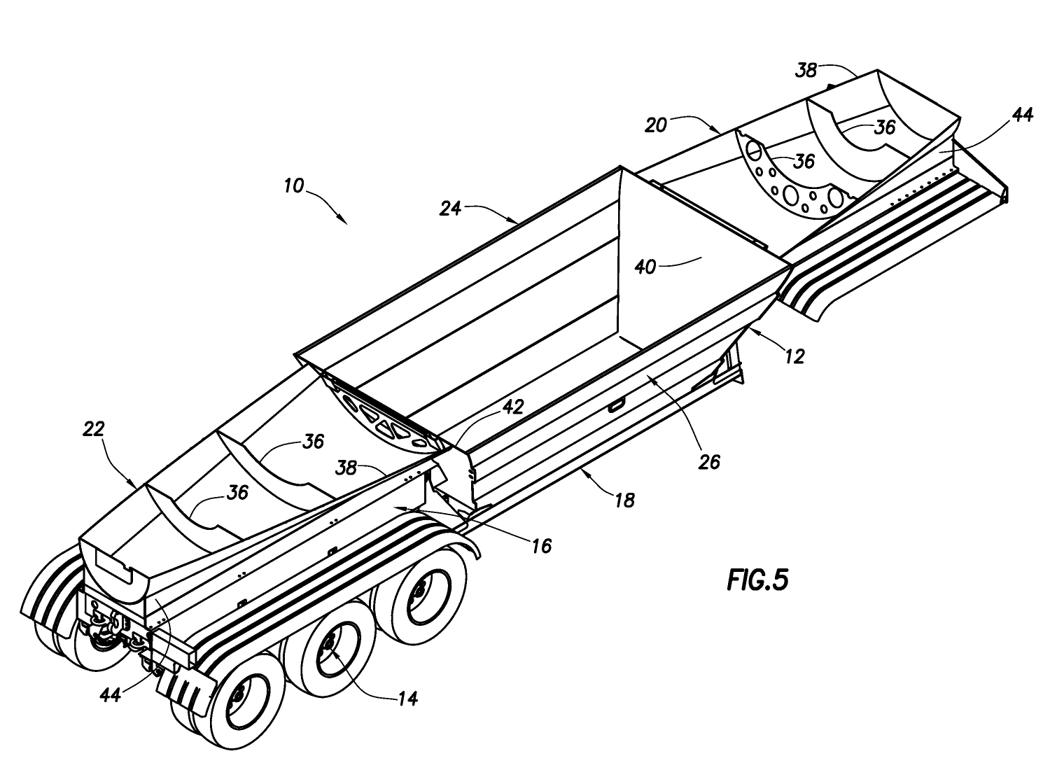

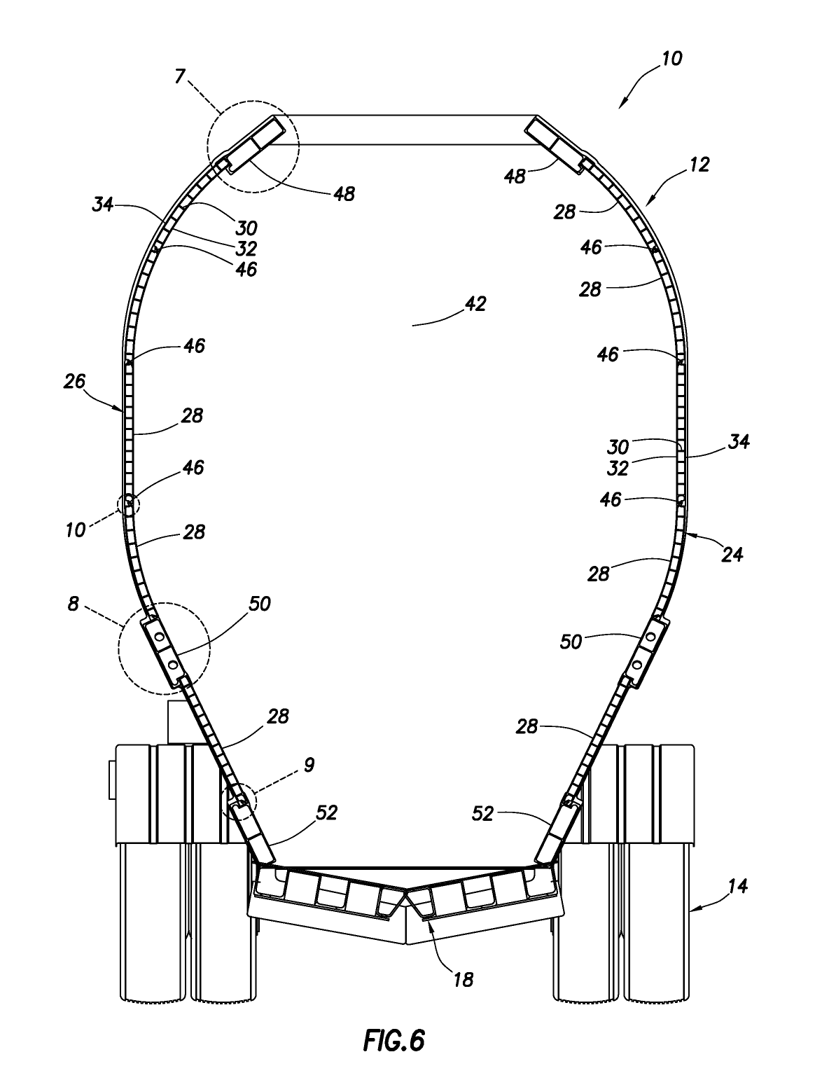

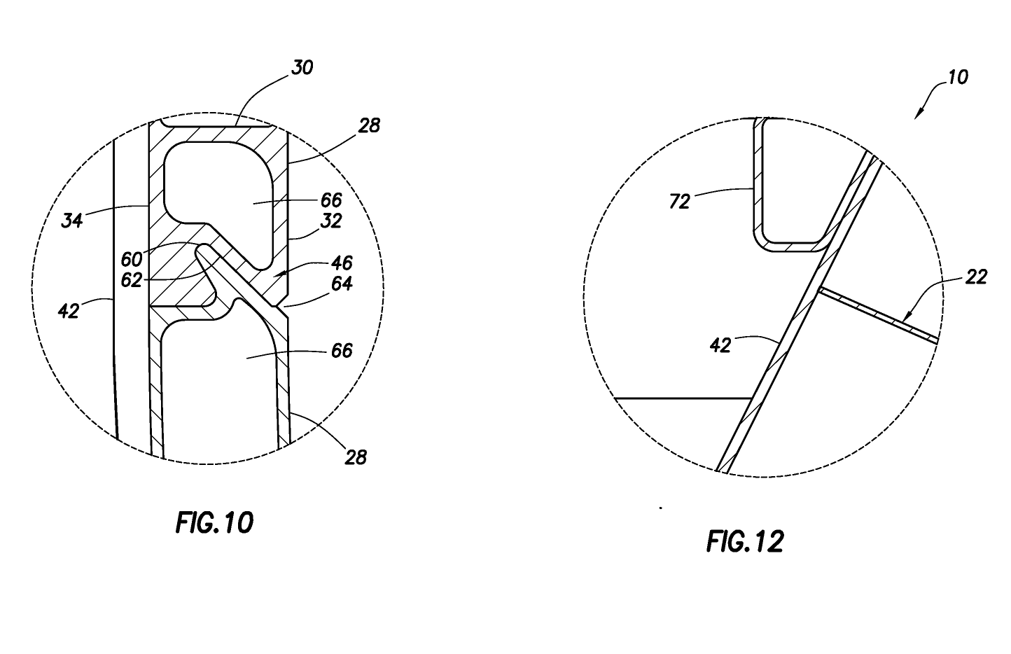

As depicted in FIG. 2, the side walls 24, 26 of the hopper 12 are made up of interconnected hollow extruded aluminum panels 28. The panels 28 may have interior webs 30 extending between interior and exterior shells 32, 34 (more clearly shown in FIGS. 6 and 10).

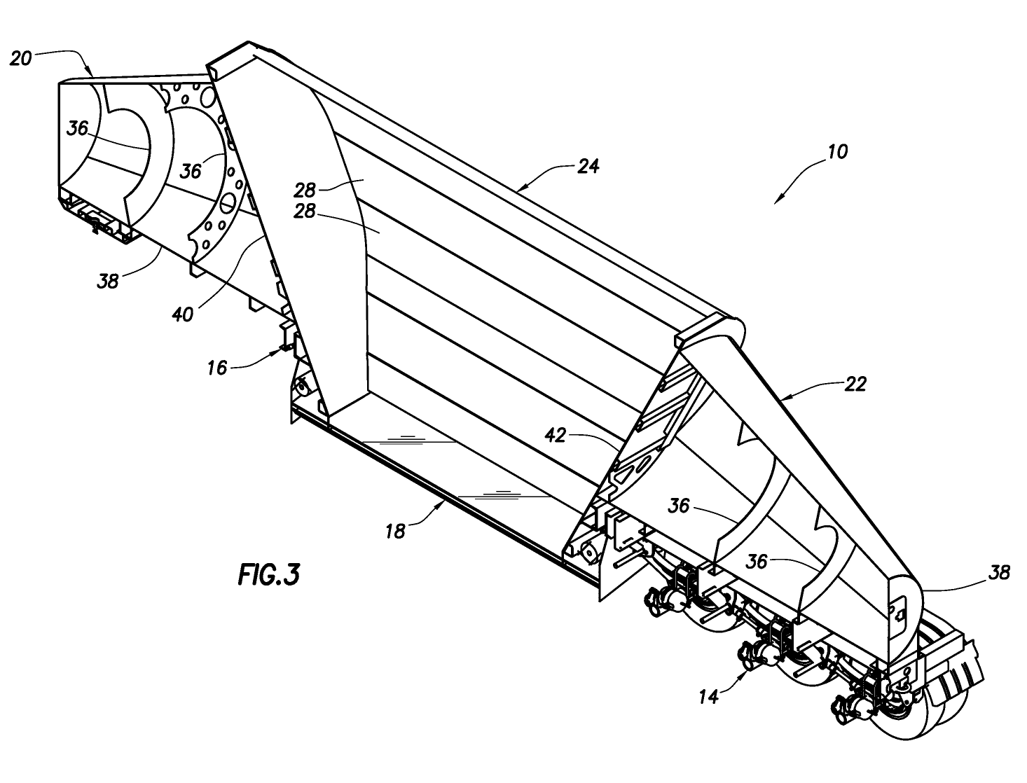

As depicted in FIG. 3, each of the cones 20, 22 includes internal stiffener rings 36 within an outer shell 38. Each of the stiffener rings 36 and outer shells 38 is preferably made of aluminum. The conical shape of the shells 38 is aerodynamic, and the construction of the cones 20, 22 is strong and light in weight.

The stiffener rings 36 may be any shape, but a circular shape is preferred if the cones 20, 22 are right circular cones. The rings 36 could be otherwise shaped if desired, for example, if the cones 20, 22 are not right circular cones (e.g., oblique cones, etc.). The weight of the stiffener rings 36 may be reduced by removing material from the annular area of one or more of the rings.

The frame 16 is attached at forward and rearward ends of the hopper 12 (e.g., at front and rear walls 40, 42, which are preferably made of aluminum). The frame 16 is also positioned beneath the cones 20, 22. The cones 20, 22 and frame 16 together provide a load-bearing structure which is light in weight, rugged and capable of carrying heavy loads in the hopper 12.

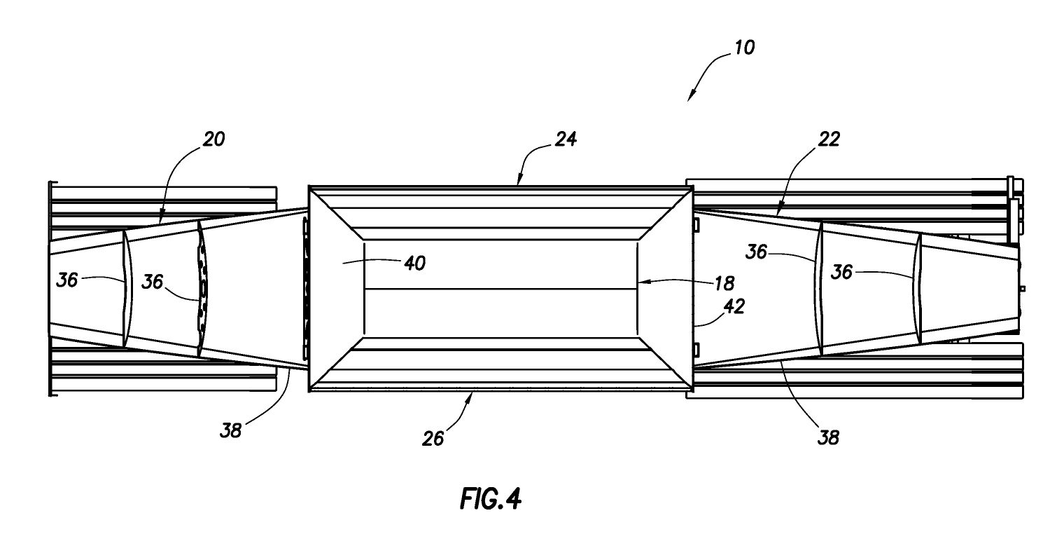

As depicted in FIG. 4, the trailer 10 construction is compact and efficient in design. The hopper 12 is centrally located between the cones 20, 22.

As depicted in FIG. 5, the frame 16 includes supports 44 beneath the cones 20, 22. The supports 44 operate to form a relatively rigid structure of the cones 20, 22 and frame 16 at the forward and rearward ends of the hopper 12.

To form a further rigidized structure of the cones 20, 22, additional supports may be provided on an upper side of the cones. For example, supports may extend from upper ends of the front and rear walls 42 outwardly from the hopper 12 to external surfaces of the cones 20, 22 on the upper sides of the cones.

As depicted in FIG. 6, the hopper 12 has a compact and efficiently designed shape, with the panels 28 making up the sides 24, 26. The panels 28 have interlocking edges 46 which operate to secure the panels to each other, and to top, side and bottom rails 48, 50, 52. The edges 46 may be further welded, adhesively bonded, fastened, etc. to each other on inner and/or outer sides thereof.

The top, side and bottom rails 48, 50, 52 are preferably made of hollow extruded aluminum. Three curved and one straight panels 28 are interconnected between the top and side rails 48, 50 on each of the sides 24, 26. A single straight panel 28 is interconnected between the side and bottom rails 50, 52 on each of the sides 24, 26.

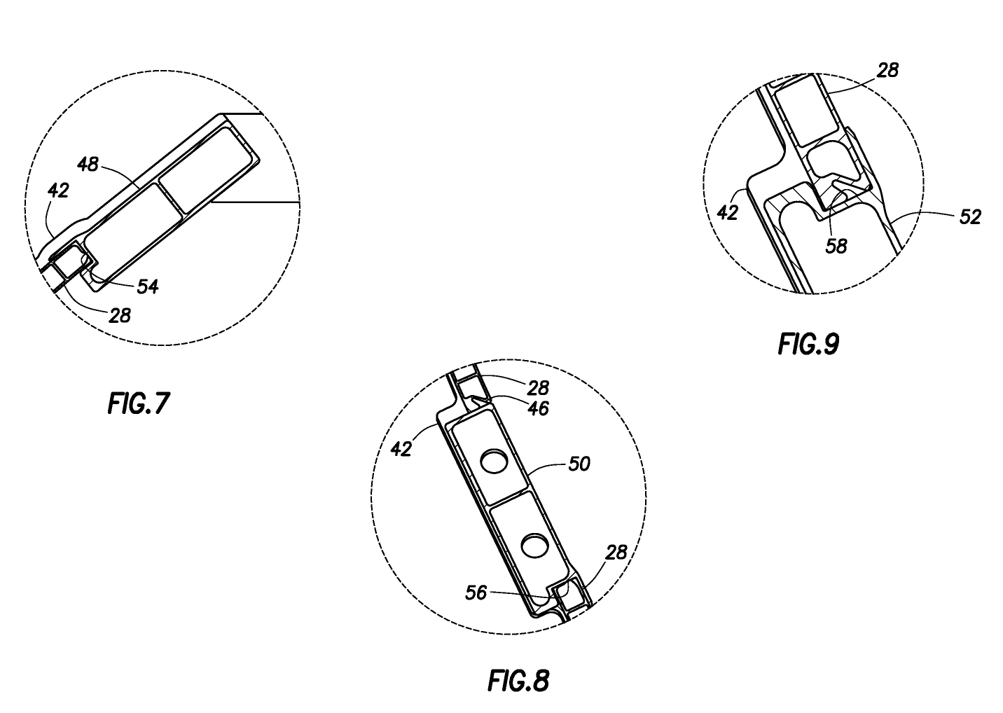

In FIG. 7 it may be seen how the top rail 48 is connected to a panel 28 (e.g., by welding, adhesively bonding, fastening, etc.), with the panel received in a recess 54 in the top rail. The top rail 48 is also connected (e.g., by welding) to each of the front and rear walls 40, 42, which are preferably made of aluminum sheet.

In FIG. 8 it may be seen how the side rail 50 is interconnected between two panels 28 (e.g., by welding, adhesively bonding, fastening, etc.), with interlocking edges 46 between an upper panel and the side rail, and a lower panel received in a recess 56 in the side rail. The side rail 50 is also connected (e.g., by welding) to each of the front and rear walls 40, 42.

In FIG. 9 it may be seen how the bottom rail 52 is interconnected below a panel 28 (e.g., by welding, adhesively bonding, fastening, etc.), with the panel received in a recess 58 in the bottom rail. The bottom rail 52 is also connected (e.g., by welding) to each of the front and rear walls 40, 42.

In FIG. 10 it may be seen how the panels 28 are interconnected to each other with the interlocking edges 46. In this example, an inclined projection 60 formed on one of the panels 28 is received in a complementarily shaped recess 62 formed on another of the panels.

A bevel or seam 64 may be provided for welding the panels 28 to each other on an interior of the hopper walls 24, 26. Alternatively, or in addition, the panels 28 may be adhesively bonded or fastened to each other. The hollow spaces 66 in the panels 28 (as well as in the top, side and bottom rails 48, 50, 52) may have a hardenable substance flowed therein for support and strengthening of the panels and rails.

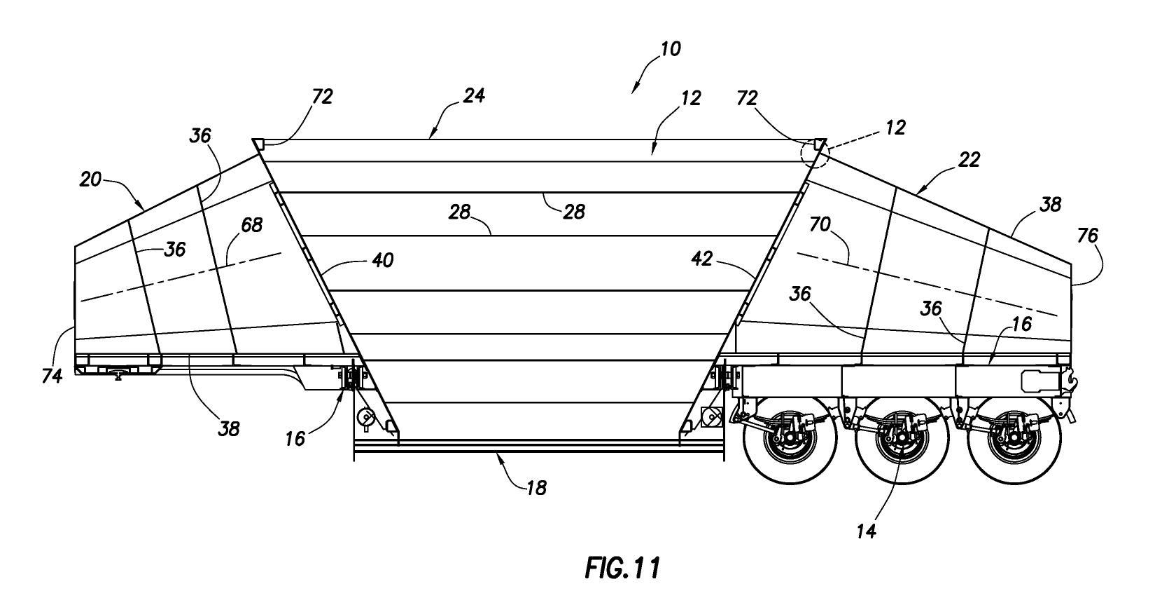

In FIG. 11 a cross-sectional view of the trailer 10 is representatively illustrated. In this view it may be seen that each of the cones 20, 22 has a central axis 68, 70 which is inclined downwardly away from the hopper 12. That is, the axis 68 of the forward cone 20 is inclined downwardly toward the frame 16 at the forward end 74 of the trailer 10, and the axis 70 of the rear cone 22 is inclined downwardly toward the frame at the rearward end 76 of the trailer.

This configuration of the cones 20, 22 relative to the hopper 12 enhances the aerodynamic efficiency of the trailer 10 (e.g., by reducing aerodynamic drag) and provides convenient and secure attachment of the lower surfaces of the cones to the frame 16 below. Note that the rings 36 are preferably oriented in respective planes perpendicular to the axes 68, 70.

In FIG. 12, an enlarged cross-sectional view of a top rail 72 on the front and rear walls 40, 42 is representatively illustrated. In this view it may be seen that the top rail 72 is secured to the interior of the wall 42 (e.g., by welding, adhesive bonding, fasteners, etc.). The top rail 72 is preferably a hollow extruded element, as with the top rail 48, side rail 50 and bottom rail 52.

Any of the elements and features described above, including the doors 18, may be made wholly or partially of aluminum or any other strong, light weight and easily fabricated material. As used herein, the term “aluminum” includes alloys of aluminum.

It will be appreciated that the foregoing description has provided a belly dump trailer 10 which includes a hopper 12 having sides 24, 26 made up of multiple hollow extruded aluminum panels 28. The trailer 10 may further include cones 20, 22 attached at forward and rearward ends of the hopper 12. The cones 20, 22 may be made of aluminum. The cones 20, 22 may be hollow and each cone may include internal stiffener rings 36 supporting an outer shell 38.

Each of the hopper sides 24, 26 may include top, side and bottom rails 48, 50, 52 interconnected to the panels 28. Each of the top, side and bottom rails 48, 50, 52 may be made of hollow extruded aluminum.

Also described is a belly dump trailer 10 which includes a hopper 12 and a cone 20 attached to the hopper. The cone 20 has an axis 68 which is inclined downwardly in a direction away from the hopper 12.

The axis 68 may be inclined toward a frame 16 of the trailer 10 in a direction away from the hopper 12.

Another cone 22 may be attached to the hopper 12. The second cone 22 may have another axis 70 which is inclined downwardly in a direction away from the hopper 12. The second axis 70 may be inclined toward a frame 16 of the trailer 10 in a direction away from the hopper 12.

The cone 20 may be hollow. At least one internal stiffener ring 36 may support an outer shell 38 of the cone 20. The stiffener ring 36 may be positioned in a plane generally perpendicular to the axis 68.

Also described is a belly dump trailer 10 which includes a hopper 12 having first and second side walls 24, 26 each made up of multiple hollow panels 28, a front wall 40 and a rear wall 42. A first cone 20 is attached to the front wall 40, and a second cone 22 is attached to the rear wall 42.

The first cone 20 may have a first axis 68 which is inclined relative to the hopper 12. The second cone 22 may have a second axis 70 which is inclined relative to the hopper 12. The first and second axes 68, 70 may be inclined downwardly in a direction away from the hopper 12. The first and second axes 68, 70 may be inclined toward a frame 16 of the trailer 10 in a direction away from the hopper 12.

The hollow panels 28, the front and rear walls 40, 42, and the first and second cones 20, 22 may be made of aluminum. The first and second cones 20, 22 may be hollow, and at least one stiffener ring 36 within each of the first and second cones 20, 22 may support an outer shell 38 of the respective cone.

The entire disclosures of U.S. Pat. No. 7,178,860 and U.S. application Ser. Nos. 11/176,037, 11/223,581 and 11/566,091 are incorporated herein by this reference for all purposes. Among other things, these incorporated reference documents describe how hollow extruded aluminum panels may be used for forming trailer walls.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A belly dump trailer, comprising:
a hopper including sides made up of multiple hollow extruded aluminum panels.

2. The trailer of claim 1, further comprising cones attached at forward and rearward ends of the hopper.

3. The trailer of claim 2, wherein the cones are made of aluminum.

4. The trailer of claim 2, wherein the cones are hollow and each cone includes internal stiffener rings supporting an outer shell.

5. The trailer of claim 1, wherein each of the hopper sides includes top, side and bottom rails interconnected to the panels.

6. The trailer of claim 5, wherein each of the top, side and bottom rails is made of hollow extruded aluminum.

7. A belly dump trailer, comprising:
a hopper; and
a first cone attached to the hopper, the first cone having a first axis which is inclined downwardly in a direction away from the hopper.

8. The trailer of claim 7, wherein the first axis is inclined toward a frame of the trailer in a direction away from the hopper.

9. The trailer of claim 7, further comprising a second cone attached to the hopper, the second cone having a second axis which is inclined downwardly in a direction away from the hopper.

10. The trailer of claim 9, wherein the second axis is inclined toward a frame of the trailer in a direction away from the hopper.

11. The trailer of claim 7, wherein the first cone is hollow.

12. The trailer of claim 7, further comprising at least one internal stiffener ring which supports an outer shell of the first cone.

13. The trailer of claim 12, wherein the stiffener ring is positioned in a plane generally perpendicular to the first axis.

14. The trailer of claim 7, wherein the hopper includes sides made up of multiple hollow extruded aluminum panels.

15. A belly dump trailer, comprising:
a hopper having first and second side walls each made up of multiple hollow panels, a front wall and a rear wall;
a first cone attached to the front wall; and
a second cone attached to the rear wall.

16. The trailer of claim 15, wherein the first cone has a first axis which is inclined relative to the hopper, and wherein the second cone has a second axis which is inclined relative to the hopper.

17. The trailer of claim 16, wherein the first and second axes are inclined downwardly in a direction away from the hopper.

18. The trailer of claim 16, wherein the first and second axes are inclined toward a frame of the trailer in a direction away from the hopper.

19. The trailer of claim 15, wherein the hollow panels, the front and rear walls, and the first and second cones are made of aluminum.

20. The trailer of claim 15, wherein the first and second cones are hollow, and wherein at least one stiffener ring within each of the first and second cones supports an outer shell of the respective cone.
